(19) United States
(12) Patent Application Publication
(10) Pub. No.: US 2005/0151967 A1
(43) Pub. Date: Jul. 14, 2005

(54) Lighting device and measuring apparatus using the same

(75) Inventor: Hideo Kusuzawa, Kobe-shi (JP)

Correspondence Address: BIRCH STEWART KOLASCH & BIRCH, PO BOX 747, FALLS CHURCH, VA, 22040-0747, US

(73) Assignee: SYSMEX CORPORATION

(21) Appl. No.: 11/023,542

(22) Filed: Dec. 29, 2004

(30) Foreign Application Priority Data
Jan. 8, 2004 (JP) 2004-001344

(51) Int. Cl. G01N 21/00

(52) U.S. Cl. 356/337

(57) ABSTRACT

A lighting device are described that include: a light source emitting light; an optical fiber having a light incident surface receiving light from the light source and a light emitting surface emitting light; and a Koehler illumination optical system comprising a collector lens and a condenser lens, the collector lens arranged opposite the light emitting surface of the optical fiber.

### FIELD OF THE INVENTION

This invention relates to a lighting device capable of Koehler illumination.

### BACKGROUND

Conventionally, an optical system of Koehler illumination has been generally employed in an optical microscope or the like. There have also been known, in addition thereto, a diffused light illumination system which shines diffused light on a specimen and a critical illumination system in which an image of a light source is focused on a specimen. The diffused light illumination system can illuminate a large area uniformly, but is weak in illuminance and besides, small in NA of illumination. The critical illumination system is not only strong in illuminance but also large in the NA, whereas illumination of non-uniformity occurs with ease since an image of a light source is formed on a specimen. Moreover, heat is also converged on a specimen surface and affects the specimen with ease. Under such circumstances, there has been employed as a standard a Koehler illumination system, large in NA, and capable of uniform, strong illumination. In a Koehler illumination system, usually, a halogen lamp or a xenon lamp is used as a light source.

FIG. 6 is a descriptive diagram showing an example of the Koehler illumination system. In a Koehler illumination system, because a light source 31 is disposed at a position farther from a collector lens 32 than the light source side focal point (front focal point) thereof, light emitted from the light source 31 passes through the collector lens 32 and thereafter, strikes a condenser lens 33 as a slightly diffused light. The image A of the light source is focused at a position of the front focal point of the condenser lens 33 by adjusting the light condensing optical system including the collector lens 32 and the condenser lens 33. Since, actually, a plane on which the image A of the light source is focused is only in the air and there is no transmissive film nor the like that reflects light irregularly or through which the light is transmitted, the image A of the light source is not visualized. Hence, no image of the light source is focused on a specimen surface 34. For description's sake, the image A of the light source is, herein, referred to as an in-air light source image. A distance between the condenser lens 33 and the specimen surface 34 is adjusted so that light passing through the condenser lens 33 is condensed on the specimen surface 34. In such a configuration, no image A of the light source with non-uniformity caused by a filament or the like is focused at the position of the specimen surface 34, thereby enabling illumination of the specimen surface 34 to be realized with almost uniform illuminance.

In the illumination system of FIG. 6, an area of the light emitting section is larger as compared with an illumination area on an illumination plane. For example, it is assumed that a length of a filament serving as the light emitting section of a lamp is 5 mm and a diameter of a desired illumination plane is 50 μm. In this case, since the diameter of the illumination plane is 1/100 time as large as the size of the light emitting section, light reaching the illumination plane is, in order to effectively use light from the light source, required to be narrowed down to a spread 1/100 time as large as the light source. For this purpose, a high magnification lens is necessary to be used as a condenser lens for light condensation. On the other hand, in order to effectively use light emitted from the light source, it is required to increase a numerical aperture NA of the collector lens. The reason therefor is that light from a lamp as the light source is emitted from the light emitting section with an angular divergence. Accordingly, a high magnification, large diameter collector lens is required in order to obtain a highly efficient lighting device. Such a requirement causes the optical system to be a large scale one. In a higher magnification collector lens, an in-air light source image is formed to be larger, which requires a large-sized condenser lens. As described above, in a case where a light source is larger than an illumination area, a higher magnification condenser lens is required and besides, in a case where a highly efficient lighting device is intended, a further higher magnification condenser lens is required. Since a large-sized, high magnification lens is expensive, the lighting device is higher in cost. Since non-coherent light emitted from a light source theoretically cannot be condensed to a size of a diffraction limit or less even if being condensed in an optical system, there is a lower limit in size of an illumination plane for a light flux to be narrowed down thereto even with a high magnification condenser lens adopted.

On the other hand, there has also been available a method in which an illumination plane is made brighter using a brighter light source without increasing an efficiency of a lighting device. If a light source is brighter, however, the lighting device is higher in cost because of an additional measure taken for heat dissipation. There arises a tendency for a lighting device to become scaled up because of heat dissipation.

After all, even if a method using a highly efficient optical system is adopted or even if a method using a brighter light source is adopted, it results in an larger-sized lighting device with a higher cost. There has been a desire for a smaller-sized lighting device with a lower cost but with a high utilization efficiency.

A scanning microscope has been known in which illuminating light emitted from a laser light source is sent to an illumination optical system through an optical fiber and thereby converged to a tiny light spot, and a specimen is two-dimensionally scanned thereon with the light spot to detect light transmitted through or irregularly reflected on the specimen (see JP-A No. 5-45588). The illumination optical system of the scanning microscope is, however, a critical illumination system in which the image of the light source is focused on a specimen surface with illumination of non-uniformity; therefore, the illumination optical system has difficulty applying to an illumination system for an optical microscope or to an illumination system for a particle analyzer.

### SUMMARY

The invention has been made in light of such circumstances and it is an object of the invention to provide a lighting device small in size, low in cost and high in utilization efficiency of light of a light source.

A lighting device of a first aspect of the invention includes: a light source emitting light; an optical fiber having a light incident surface receiving light from the light source and a light emitting surface emitting light; and a Koehler illumination optical system comprising a collector lens and a condenser lens, the collector lens arranged opposite the light emitting surface of the optical fiber.

A lighting device of a second aspect of the invention includes: a light source having a light emitting surface with an area in the range of from 0.001 mm² to 1 mm² emitting light; and a Koehler illumination optical system comprising a collector lens and a condenser lens, the collector lens arranged opposite the light emitting surface of the light source.

A particle measuring apparatus of a first aspect of the invention includes: a light source emitting light; an optical fiber having a light incident surface receiving light from the light source and a light emitting surface emitting light; a Koehler illumination optical system comprising a collector lens and a condenser lens, the collector lens arranged opposite the light emitting surface of the optical fiber; a flow cell through which particles flows; an image pick-up device for picking up the images of particles illuminated with light from the Koehler illumination optical system; and an image processing section for processing the images of particles picked up by the image pick-up device.

A particle measuring apparatus of a second aspect of the invention includes: a light source having a light emitting surface with an area in the range of from 0.001 mm² to 1 mm² emitting light; a Koehler illumination optical system comprising a collector lens and a condenser lens, the collector lens arranged opposite the light emitting surface of the light source; a flow cell through which particles flows; an image pick-up device for picking up the images of particles illuminated with light from the Koehler illumination optical system; and an image processing section for processing the images of particles picked up by the image pick-up device.

### BRIEF DESCRIPTION OF THE DRAWINGS

FIG. 1 is a descriptive diagram showing a construction of an embodiment of a lighting device.

FIG. 2 is a descriptive diagram showing a possibility of down-sizing of a Koehler illumination system using two light sources having light emitting areas different from each other in a case of illumination at the same light power density.

FIG. 3 is a sectional view showing a receptacle for an optical fiber playing an additional role as a light condensing optical system guiding light from an LED to the optical fiber.

FIG. 4 is a sectional view showing a different embodiment of an optical source used in a lighting device.

FIG. 5 is a descriptive view showing an arrangement of a lighting device in a case where the lighting device is applied in a particle measuring instrument.

FIG. 6 is a descriptive diagram showing an example of the Koehler illumination system.

### DETAILED DESCRIPTION OF THE PREFERRED EMBODIMENTS

Description will be given of embodiments of the invention based on the accompanying drawings.

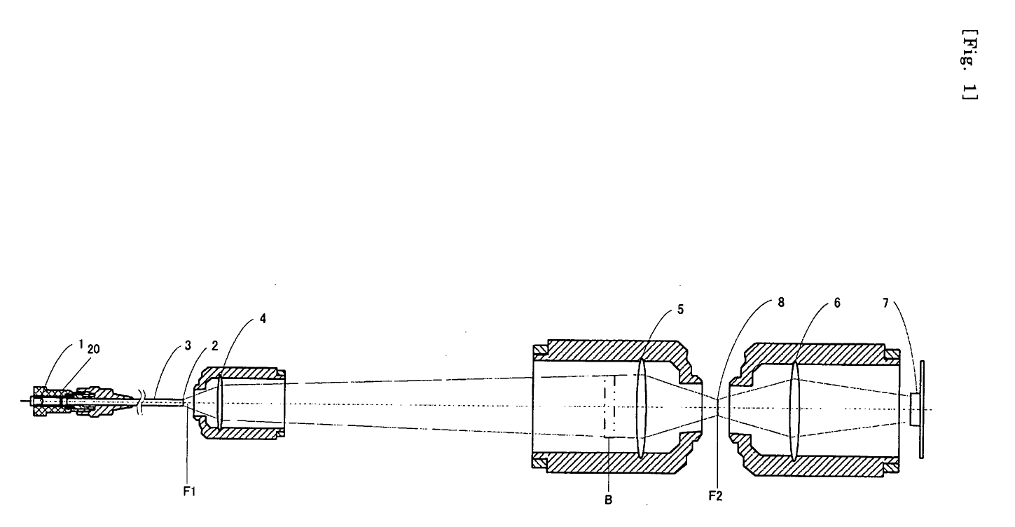

FIG. 1 is a descriptive diagram showing a construction of an embodiment of a lighting device of the invention. In FIG. 1, a numerical symbol 1 indicates an LED serving as an light emitting section of a light source, 3 an optical fiber and 2 an end surface of the optical fiber serving as an light emitting surface. A numerical symbol 20 indicates a receptacle and plays an additional role as a light condensing optical system guiding light from the LED 1 to the optical fiber 3. Light from the LED 1 is introduced into one end surface of the optical fiber 3 in the receptacle 20 and emitted from the other end. The other end is disposed in the vicinity of a focal point F1 of a collector lens 4 at a position slightly shifted from the focal point F1 to the outside. The other end is the light emitting surface of the light source. In an embodiment, a size of the light emitting section of the LED 1 is 1 mm×1 mm, diameters of the light emitting surfaces of the optical fibers are of 4 kinds of 800 μm, 180 μm, 120 μm, and 50 μm.

The optical fiber 3 is exchangeable so as to use one with a different diameter of the light emitting surface when required. That is, since the optical fiber 3 demountably fits in an engagement portion of the receptacle 20, the optical fiber 3 can be exchanged with another having the optimal light emitting area so as to be adapted for a necessary illumination area.

A numerical symbol 5 indicates a condenser lens, which together with the collector lens 4 on the light source side constitutes a Koehler illumination system, which illuminates a specimen disposed at an illumination plane 8. Transmitted light from the specimen illuminated with the illumination light is guided to a CCD 7 of the light receiving device disposed near the other side of an image focusing lens 6 from the illumination plane 8 to focus an image of the specimen disposed at the illumination plane onto the light receiving surface of the CCD 7. In an embodiment, a size of the light receiving surface of the CCD is 4.4 mm×3.3 mm.

The lighting device of FIG. 1 is constructed so that a Koehler illumination system from the light emitting surface 2, through the collector lens 4, through the condenser lens 5 and to the illumination plane 8 is integrally in a single piece placed therein and can move along the optical axis direction, wherein the illumination system moves to or way from the illumination plane 8 to thereby enable an area of the illumination plane to be selected in a desired way. The collector lens 4 and the condenser lens 5 are both spherical lenses.

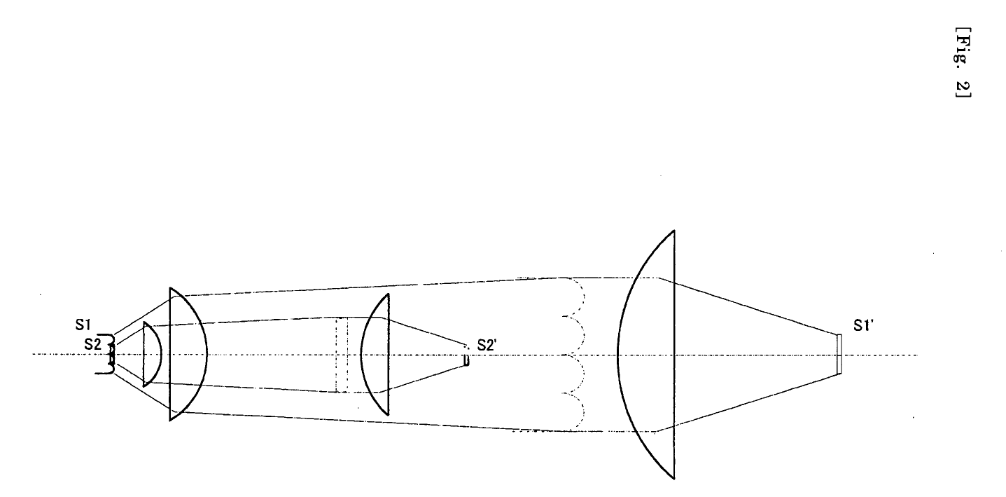

FIG. 2 is a descriptive diagram showing a possibility of down-sizing of a Koehler illumination system using two light sources having light emitting areas different from each other in a case where the same illumination areas as the light sources are illuminated at the same light power density. A total amount of light energy is proportional to an area of the light emitting surface with a given numerical aperture under an energy conservation law. Light energy per a unit area is the same. Hence, with the same numerical aperture NA1 adopted, a light source with a larger light emitting area S1 is in a relation of similarity with a Koehler illumination system having a light source with a smaller light emitting area S2. In this case, the illumination areas are also in a relation of similarity with each other. In FIG. 2, an illumination area S1′ is obtained for the light emitting area S1, while a illumination area S2′ is obtained for the light emitting area S2. In a case where a necessary illumination area is S2′ or less, a construction constituted of a light source with a small light emitting area S2 and an small-sized illumination system being adapted therefor, if being possible, enables a lighting device to be down-sized, which realizes a lighting device that has the same light power density on the illumination plane as in a case where a light source with a larger light emitting area S1 is adopted.

Table 1 shows dimensions of constituents and characteristics of illumination systems in cases where 4 kinds of optical fibers with the respective diameters of light emitting surfaces including 800 μm, 180 μm, 120 μm and 50 μm are disposed at a position spaced from the focal point F1 of a collector lens 4 with a focal length of 4.0 mm and a numerical aperture of 0.75 by a distance L1 so as to be away from the collector lens 4, a condenser lens 5 with a focal length of 2.0 mm and a numerical aperture of 0.8 is disposed away from the other side of the collector lens 4 from the light source and the illumination plane on the other side of the condenser lens 5 from the light source is illuminated. A distance L2 is a distance from the light emitting surface of the optical fiber 3 to the illumination plane illuminating a specimen, that is the total length of a Koehler illumination system. A diameter L4 is a diameter of an in-air light source image B formed in the vicinity of a focal point on the other side of the condenser lens 5 from the illumination plane, that is a diameter of an optical fiber, in a case where, for the optical fibers 3 with the respective diameters, the collector lens 4 and the condenser lens 5 are as described above disposed apart from the respective focal points F1 and F2 by distances L1 and L2 so as to be away from the lenses and a distance between the collector lens 4 and the condenser lens 5 is adjusted so as to obtain a total length of an illumination system shown as L2 in Table 1. Distances of the optical systems are in all the cases set so that distances L4 are set to 3.200 mm. Therefore, although an optical system in a relation of similarity as shown in FIG. 2 is constructed in each of different diameters of light emitting surfaces, there is shown an example of a size of an optical system in a case where the optical system concerning the invention is constructed using a collector lens and a condenser lens actually available. In Table 1, a diameter of an illumination plane illuminating a specimen is set to L5 for the diameters of respective light emitting surfaces. An area of a light emitting surface is indicated with S, which case an area of the illumination plane is indicated with S.′

TABLE 1

| Fiber light | Light | | | | | | |
|---|---|---|---|---|---|---|---|
| emitting | emitting | | | | | | Illumination |
| surface | surface | | | | | | plane |
| diameter | area | L 1 | L 2 | L 3 | L 4 | L 5 | area S′ |
| (μm) | (mm²) | (mm) | (mm) | (mm) | (mm) | (μm) | (mm²) |
| 800 | 0.503 | 0.625 | 102.681 | 0.156 | 3.200 | 250 | 0.049 |
| 180 | 0.102 | 0.225 | 147.692 | 0.056 | 3.200 | 113 | 0.010 |
| 120 | 0.045 | 0.150 | 183.154 | 0.038 | 3.200 | 75 | 0.004 |
| 50 | 0.008 | 0.063 | 332.738 | 0.016 | 3.200 | 31 | 0.001 |

In a case of Table 1 where an optical fiber of 800 μm is used, since a magnification of the collector lens 4 is excessively high to thereby cut away an end portion of the light emitting surface on an in-air light source image B, part of light from the light emitting surface does not strike the illumination plane. That is, an area of the light emitting surface is excessively large relative to an illumination system of the embodiment. Eventually, in Table 2 shown below, a utilization efficiency of light of the light source stays at a low value in the case of the optical fiber of 800 μm is used.

A total length L2 of an illumination system takes a value in the range of from 102.681 mm to 332.378 mm according to a diameter of the light emitting surface. In comparison therewith, the total length of a conventional, optical system, which uses a xenon lamp as a light source and an objective lens with an equal performance (curvature), is on the order of about 600 mm. It is understood from the numerical values that an illumination system can be down-sized with a light source having a smaller light emitting area.

As shown in Table 1, a total length of an optical system of a lighting device of the invention with the light emitting area in the range of from 0.001 mm² to 0.049 mm² can be smaller to a value from 0.17 to 0.55 times as large, as compared with the conventional optical system. Although a light emitting area is not limited in the range, a difference from an conventional optical system is lost if being excessively larger, while a light source with a larger light density becomes necessary if being excessively smaller, therefore, a light emitting area is preferably in the range of from 0.001 mm² to 1 mm².

It can be known from values of L5 in Table 1 which diameter of the light emitting surface of an optical fiber should be selected in order to obtain a desired illumination area in the illumination system of the embodiment.

Table 2 shows utilization efficiency values η of light of a light source in cases of three kinds of image focusing lenses with respective different magnifications including ×40, ×60 and ×100 adopted in the illumination system of Table 1 illuminating the illumination plane with each of 4 kinds of diameters of an optical fiber light emitting surface including 800 μm, 180 μm, 120 μm and 50 μm.

In the embodiment, a case where transmitted light from the illumination plane 8 is received on a circular area with a diameter of 2.8 mm of the CCD 7 serving as a light receiving device is assumed to be a case using the light receiving surface with the maximum diameter. A diameter of the illumination plane 8 corresponding thereto is L6 and an illumination efficiency in conditions, that is a quotient obtained when a light quantity impinging on the illumination plane is divided by a light quantity from the light emitting surface of an optical fiber, is η by definition.

TABLE 2

| | | Light | Light | Light | Light |
|---|---|---|---|---|---|
| | | emitting | emitting | emitting | emitting |
| | | surface | surface | surface | surface |
| | L 6 | diameter | diameter | diameter | diameter |
| Magnification | (mm) | 800 μm | 180 μm | 120 μm | 50 μm |
| ×40 | 0.069 | 1.66% | 32.82% | 73.85% | 87.89% |
| ×60 | 0.046 | 0.84% | 16.60% | 37.35% | 100.00% |
| ×100 | 0.028 | 0.30% | 5.98% | 13.44% | 77.44% |

It is found from Table 2 that the highest utilization efficiency of light from a light source is obtained in a case where a specimen is illuminated with an optical fiber with a diameter of the light emitting surface of 50 μm and a image focusing lens with a magnification of ×60 is used. That is, it is understood that a utilization efficiency of light from a light source is high when an area of the light emitting surface is equal to an area of the illumination plane. In this case, the illumination plane with the CCD on which an image is focused is all within a region with a diameter of 2.8 mm. Even in a case of an image focusing lens with a magnification as low as ×40 used, the illumination plane with the CCD on which an image is focused is all within a region with a diameter of 2.8 mm, whereas since an optical power density exceeds a dynamic range of the CCD 7 and is saturated, a total received light quantity that the CCD 7 can actually catch levels off, thereby disabling 100% as a value of η to be obtained.

The illumination plane on which an image is focused that is not excessively smaller than a circle with a diameter of 2.8 mm, from the viewpoint of the number of light receiving pixels of the CCD 7, more effectively uses the pixels thereof. Therefore, in a practical aspect, such a factor should also be considered in selection of the optimal diameter of an optimal optical fiber and the optimal magnification of an image focusing lens. Since a size of the light receiving surface of the CCD 7 of the embodiment is actually of 4.4 mm×3.3 mm, a margin is still available in a case of a region with a diameter of 2.8 mm even in consideration of arrangement error. Therefore, other factors to be considered for the optimal selection in a practical aspect have only to include a combination of an optical fiber with a diameter of the light emitting surface of 50 μm and an image focusing lens of a magnification of ×100, a combination of an optical fiber with a diameter of the light emitting surface of 120 μm and an image focusing lens of a magnification of ×40 and the like.

In order to obtain a high efficiency lighting device, as described above, it is especially preferable that a diameter of the light emitting surface of an optical fiber is in the range of from 50 to 120 μm, that is an area of the light emitting surface is in the range of from 0.001 mm² to 0.004 mm².

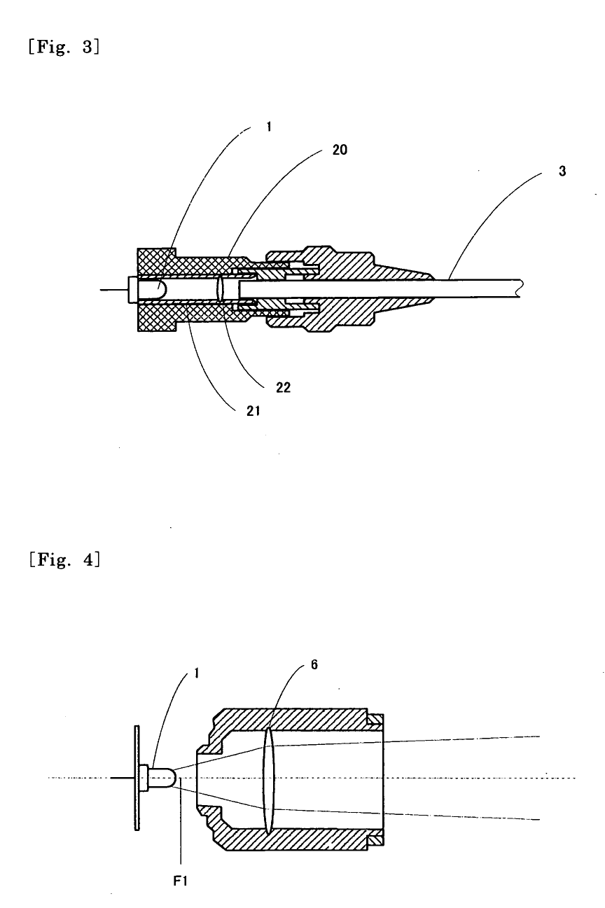

FIG. 3 is a detailed sectional view showing the receptacle 20 for an optical fiber 3 playing an additional role as the light condensing optical system 2 guiding light from the LED 1 serving as a light emitting section to the optical fiber 3 in the embodiment. The LED 1 is inserted into the receptacle 20 and fixed there. Light emitted from the LED 1 diverges in every direction at an angle and has a directivity to be radiated with the greatest intensity along the optical axis in which a condensing lens 22 is disposed. This phenomenon is greatly affected by arrangement of a LED chip not shown constituting the LED 1 and shapes of molded members surrounding the LED 1. Light emitted from the LED 1 is guided to the lens 22 along a sleeve 21. The sleeve 21 are made of a material having reflectivity so that light reflected on the inner wall propagates while being directly reflected. An end of the optical fiber 3 is disposed on the other side of the lens 22 from the LED 1. Light propagates the interior of the sleeve 21 in parallel or almost parallel to the optical axis and light passing through the lens 22 is condensed and guided into the interior of the optical fiber 3 from the end thereof. Incident light at a sufficiently low angle relative to the axis of the optical fiber 3 propagates in the optical fiber 3 with almost no attenuation to reach the light emitting surface at the other end.

Since the LED 1 has a light emitting section with an area smaller than a halogen lamp or a xenon lamp conventionally adopted and a directivity for light radiation is sharper than the lamps, light from the light emitting section can be efficiently condensed and introduced into the optical fiber 3.

While in the embodiment, an LED is used as a light emitting section, the light emitting section is only required to be a unit emitting non-coherent light and an LED is preferable, but the light emitting section is not limited to the LED. Examples thereof may include: an halogen lamp and a xenon lamp both of which have been conventionally employed; and a device producing partially coherent light by passing light emitted from a laser light source through a phase modulator or an optical fiber.

While in the embodiment, spherical lenses are used as a collector lens and a condenser lens, no-spherical lenses may be used instead.

FIG. 4 is a sectional view showing a different embodiment of an optical source used in a lighting device. In FIG. 4, an LED 1 is disposed in the vicinity of the focal point F1 of a collector lens 4 and a surface of the LED 1 serves as the light emitting surface of a light source. Since the LED 1 itself generates almost no heat as compared with a halogen lamp and a xenon lamp that have been conventionally employed, is of a small area and has sharp directivity, the surface of the LED 1 can be used directly as the light emitting surface. In a case where an illumination area is almost equal to the light emitting section area of the LED 1, such a light source may be used in the lighting device.

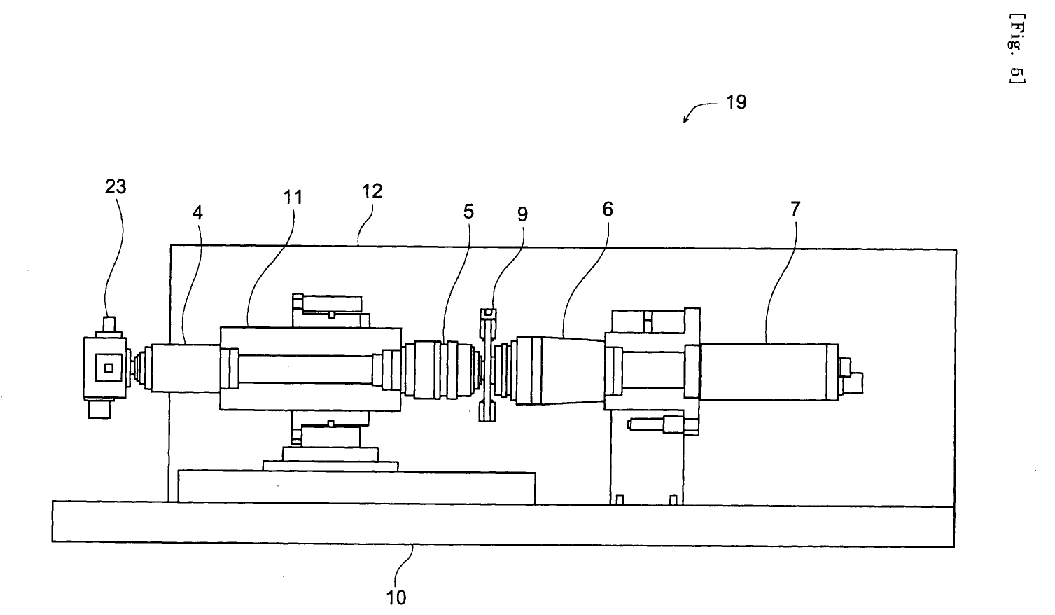

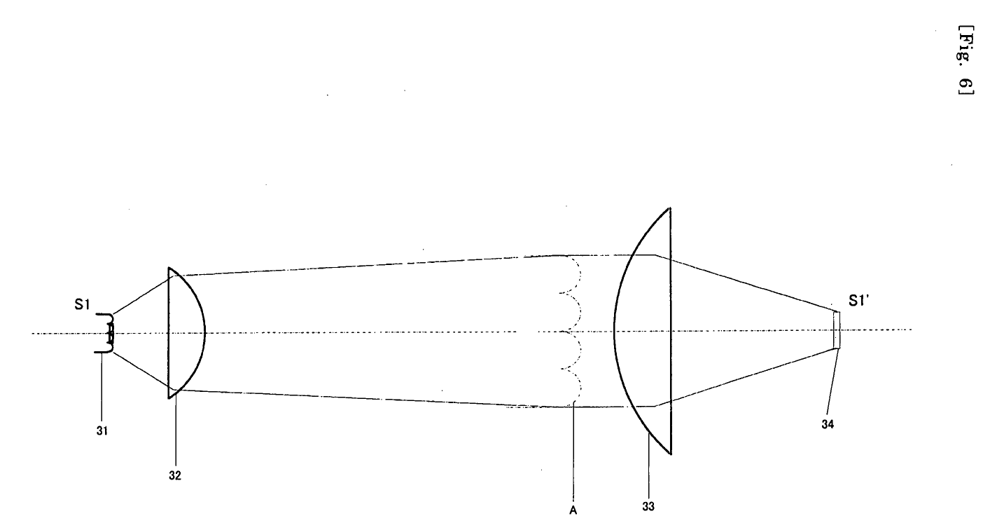

FIG. 5 is a descriptive view showing an arrangement of a lighting device in a case where the lighting device of the embodiment is applied in a particle measuring instrument. In the particle measuring instrument, a specimen for measurement, that is particles, passes through a flow cell 9. In the instrument shown in the embodiment, particles passing through the flow cell 9 are illuminated with a lighting device. An illumination system and an image pick-up system including the lighting device, an image focusing lens 6 and an image pick-up device 7 are housed inside a darkroom 12. The illumination system and the image pick-up system are designed so as not to cause error or strain in arrangement of the optical system by external vibration and a way of installment of the instrument while being mounted on a base 10 machined to a high precision and high in stiffness. The illumination system constructed integrally in a single piece with a light source unite 23 having an LED as the light source, an optical fiber exchangeable when required and a light emitting surface therein; and a collector lens 4 and a condenser lens 5 mounted at both ends of a cylinder 11 can move along the optical axis relative to the flow cell 9 including an illumination plane inside thereof and can select a desired illumination area. In addition, the particle measuring instrument may include: a particle introducing section not shown; an input section for inputting an operation or a command to the instrument; an image processing section processing a picked-up image; a display section presenting a processed image, a result of the processing, settings of the instrument or the like; an output section outputting contents of a display; and a control section controlling operations in parts of the instrument.

Since a lighting device of the embodiment has an area of the light emitting surface emitting light in the range of from 0.001 mm² to 1 mm²,a Koehler illumination system guiding light from the light emitting surface to the illumination plane can be scaled down, thereby enabling the lighting device and the instrument in which the lighting device is incorporated to be smaller in size. This is because with an area of the light emitting surface smaller than in a conventional practice, a collector lens with the same numerical aperture as conventional can be smaller in diameter thereof, which allows a condenser lens even smaller in diameter. Since the light source is smaller, no necessity arises for use of a high magnification condenser lens. Accordingly, a small-sized lighting device with uniform illuminance and with non-uniformity in illumination at a low level can be obtained using a Koehler illumination system. Even with a down-sized lighting device adopted, a luminance equal to a conventional level can be obtained on an illumination plane. The reason therefor is that light of a light source can be condensed to only a necessary region with an unnecessary region not illuminated.

With the lighting device or the instrument smaller in size, it is expected that a floor space thereof can be saved or the lighting device or the instrument can be fabricated at lower cost. Especially, since a lens diameter may be smaller, it can also be expected to fabricate a collector lens and a condenser lens at lower cost.

1. A lighting device comprising:
a light source emitting light;
an optical fiber having a light incident surface receiving light from the light source and a light emitting surface emitting light; and
a Koehler illumination optical system comprising a collector lens and a condenser lens, the collector lens arranged opposite the light emitting surface of the optical fiber.

2. The lighting device of claim 1, wherein the light source is a xenon lamp.

3. The lighting device of claim 1, wherein the light source is a LED.

4. The lighting device of claim 1, further comprising an optical system condensing light from the light source to guide the light to the light incident surface of the optical fiber.

5. The lighting device of claim 1, wherein the optical fiber is arranged so as to be exchangeable.

6. The lighting device of claim 1, wherein at least one of a distance from the light emitting surface to the collector lens, a distance from the collector lens to the condenser lens and a distance from the condenser lens to an illumination plane can be changed.

7. The lighting device of claim 1, wherein an area of the light emitting surface is in the range of from 0.001 mm² to 1 mm².

8. A lighting device comprising:
a light source having a light emitting surface with an area in the range of from 0.001 mm² to 1 mm² emitting light; and
a Koehler illumination optical system comprising a collector lens and a condenser lens, the collector lens arranged opposite the light emitting surface of the light source.

9. The lighting device of claim 8, wherein the light source is an LED.

10. The lighting device of claim 8, wherein at least one of a distance from the light emitting surface to the collector lens, a distance from the collector lens to the condenser lens and a distance from the condenser lens to an illumination plane can be changed.

11. A particle measuring apparatus comprising:
a light source emitting light;
an optical fiber having a light incident surface receiving light from the light source and a light emitting surface emitting light;
a Koehler illumination optical system comprising a collector lens and a condenser lens, the collector lens arranged opposite the light emitting surface of the optical fiber;
a flow cell through which particles flows;
an image pick-up device for picking up the images of particles illuminated with light from the Koehler illumination optical system; and
an image processing section for processing the images of particles picked up by the image pick-up device.

12. The particle measuring apparatus of claim 11, wherein the light source is a xenon lamp.

13. The particle measuring apparatus of claim 11, wherein the light source is a LED.

14. The particle measuring apparatus of claim 11, further comprising an optical system condensing light from the light source to guide the light to the light incident surface of the optical fiber.

15. The particle measuring apparatus of claim 11, wherein the optical fiber is arranged so as to be exchangeable.

16. The particle measuring apparatus of claim 11, wherein at least one of a distance from the light emitting surface to the collector lens, a distance from the collector lens to the condenser lens and a distance from the condenser lens to an illumination plane can be changed.

17. The particle measuring apparatus of claim 11, wherein an area of the light emitting surface is in the range of from 0.001 mm² to 1 mm².

18. A particle measuring apparatus comprising:
a light source having a light emitting surface with an area in the range of from 0.001 mm² to 1 mm² emitting light;
a Koehler illumination optical system comprising a collector lens and a condenser lens, the collector lens arranged opposite the light emitting surface of the light source;
a flow cell through which particles flows;
an image pick-up device for picking up the images of particles illuminated with light from the Koehler illumination optical system; and
an image processing section for processing the images of particles picked up by the image pick-up device.

19. The particle measuring apparatus of claim 18, wherein the light source is an LED.

20. The particle measuring apparatus of claim 18, wherein at least one of a distance from the light emitting surface to the collector lens, a distance from the collector lens to the condenser lens and a distance from the condenser lens to an illumination plane can be changed.
